(19) United States
(12) Patent Application Publication
(10) Pub. No.: US 2011/0314067 A1
(43) Pub. Date: Dec. 22, 2011

(54) COMPUTER READABLE MEDIUM AND OBJECT MANAGEMENT APPARATUS

(75) Inventor: Kiyoshi TERAGUCHI, Kanagawa (JP)

(73) Assignee: FUJI XEROX CO., LTD., Tokyo (JP)

(21) Appl. No.: 12/955,963

(22) Filed: Nov. 30, 2010

(30) Foreign Application Priority Data
Jun. 21, 2010 (JP) 2010-140334

(51) Int. Cl. G06F 17/30

(52) U.S. Cl. 707/821; 707/E17.055

(57) ABSTRACT

A computer readable medium stores a program causing a computer to execute a process for managing an object. The process includes displaying, storing, acquiring, and editing steps. In the displaying step, a first name of a first object stored in a first storage area is displayed. In the displaying step, a second name of a second object stored in a second storage area is displayed together with at least one of items of a second attribute of the second object. The at least one of the items is selected as an object to be displayed. In the storing step, the second object stored in the second storage area is stored in the first storage area in response to a storage instruction for storing the second object in the first storage area. In the acquiring step, the at least one of the items of the second attribute is acquired.

### CROSS-REFERENCE TO RELATED APPLICATIONS

This application is based upon and claims priority under 35 USC 119 from Japanese Patent Application No. 2010-140334, filed Jun. 21, 2010.

### BACKGROUND

### Technical Field

The present invention relates to a computer readable medium and an object management apparatus.

### SUMMARY OF THE INVENTION

According to an aspect of the invention, a computer readable medium stores a program causing a computer to execute a process for managing an object. The process includes displaying, storing, acquiring, and editing steps. In the displaying step, a first name of a first object stored in a first storage area is displayed. In the displaying step, a second name of a second object stored in a second storage area is displayed together with at least one of items of a second attribute of the second object. The at least one of the items is selected as an object to be displayed. In the storing step, the second object stored in the second storage area is stored in the first storage area in response to a storage instruction for storing the second object in the first storage area. In the acquiring step, the at least one of the items of the second attribute is acquired. In the editing step, the second name is edited to include the second name and the at least one of the items of the second attribute when the first name becomes identical to the second name of the second object stored in the first storage area due to the storage instruction.

### BRIEF DESCRIPTION OF THE DRAWINGS

Exemplary embodiments of the invention will be described in detail based on the following figures:

FIG. 1 is a schematic block diagram illustrating an example of a file management system in accordance with this exemplary embodiment;

FIG. 2 is a schematic block diagram illustrating an example of a hardware configuration of the file management system in accordance with this exemplary embodiment;

FIG. 3 is a diagram illustrating an example of a display screen of information concerning files under management by a file management system B in this exemplary embodiment;

FIG. 4 is a diagram illustrating an example of the display screen of information concerning files under management by a file management system A in this exemplary embodiment;

FIG. 5 is a flowchart illustrating an example of file naming processing in this exemplary embodiment;

FIG. 6 is a flowchart illustrating an example of file abbreviation processing in this exemplary embodiment;

FIG. 7 is a diagram illustrating an example of files stored in a folder under management by the file management system B in this exemplary embodiment;

FIG. 8 is a diagram illustrating another example of files stored in a folder under management by the file management system B in this exemplary embodiment; and

FIG. 9 is a diagram illustrating still another example of files stored in a folder under management by the file management system B in this exemplary embodiment.

### DETAILED DESCRIPTION

Hereafter, a description will be given of a preferred exemplary of the present invention with reference to the drawings.

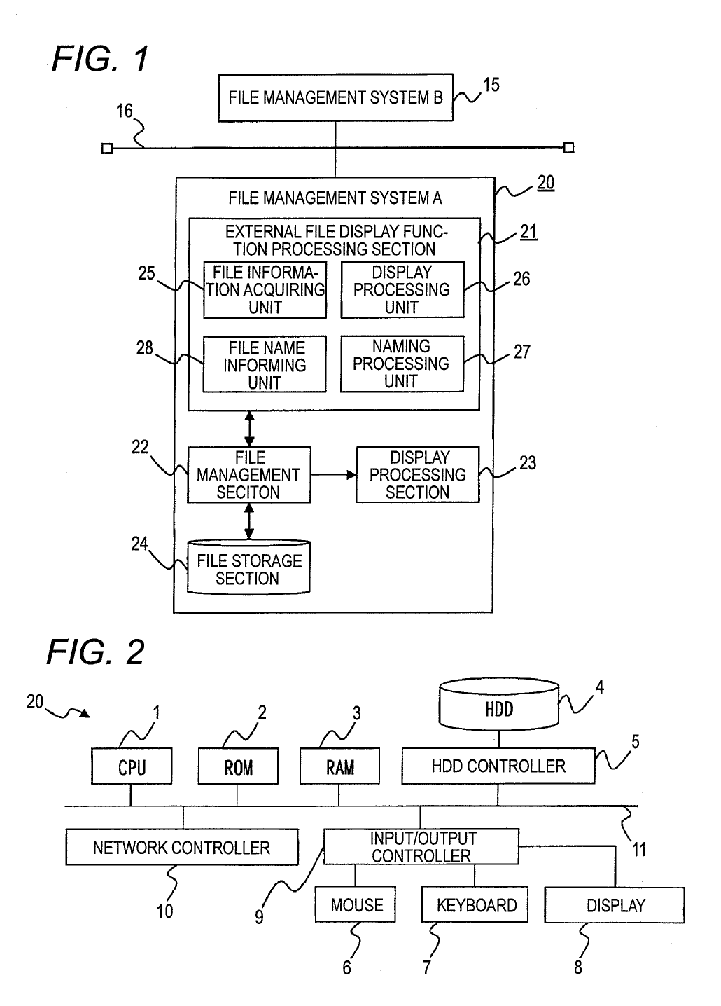

FIG. 1 is a diagram illustrating an example of a block configuration showing an exemplary of the invention. A file management system A 20 and a file management system B 15, which are connected by a network 16 and are capable of data communication, are shown in FIG. 1. The respective systems 20 and 15 are realized with file systems installed on a computer. The file management system A 20 uses a file system which does not allow an object with an identical name to be stored in an object storage area. For example, Net File System (NTFS) provided by Microsoft Corporation corresponds to this. In contrast, the file management system B 15 in this exemplary uses a file system allows an object with an identical name to be stored in an object storage area.

Here, the object storage area means a folder, a directory, or the like. In addition, the object refers to a file, a folder, a directory, or the like which is subject to storage in a folder, a directory, or the like. In the following description, a description will be given by citing as an example a case where the object storage area is a folder, and the object is a file.

FIG. 2 is a diagram illustrating an example of the hardware configuration of the file management system A 20 in this exemplary. In this exemplary, the computer which forms the file management system A 20 may be realized by a general-purpose hardware configuration which is conventionally available. Namely, as shown in FIG. 2, the computer is configured such that an HDD controller 5 with a CPU 1, a ROM 2, a RAM 3, and a hard disk drive (HDD) 4 connected thereto, an input/output controller 9 to which a mouse 6 and a keyboard 7 provided as input means and a display 8 provided as a display unit are respectively connected, and a network controller 10 provided as a communication means are connected to an internal bus 11. It should be noted that since the file management system B 15 is also a computer, its hardware configuration may be illustrated in the same way as FIG. 2.

Returning to FIG. 1, the file management system A 20 in this exemplary has an external file display function processing section 21, a file management section 22, a display processing section 23, and a file storage section 24. The external file display function processing section 21 functions as a second object display processing means, is under management outside of the file management system A 20, i.e., under management by the file management system B 15 in this exemplary embodiment, and displays files which are stored by being sorted according to folders serving as second storage areas. Various attributes including the date of preparation, version, and the like are set for each file, and the external file display function processing section 21 displays attributes selected by the user or the system as objects of display from among these attributes in correspondence with the name of each file. The attribute selected as an object of display from among these attributes will be particularly referred to as the “display attribute.” The file management section 22 manages files under management by the file management system A 20. Files which are subject to management are stored in the file storage section 24 by being sorted for each folder as a first storage area. Further, the file management section 22 is provided as a storage processing means, and, in response to a storage instruction for storing a file stored in a folder under management by the file management system B 15 in a folder in the file storage section 24 designated as a storage destination, stores the storage-instructed file in the relevant folder. The display processing section 23 functions as a first object display processing means, is realized by an application for display, such as Microsoft Corporation's Explorer, and displays files under management by the file management system A 20 on the display 8. It should be noted that although the display processing section 23 is described, for convenience' sake, as displaying files under management by the file management system A 20, the display processing section 23 is also capable of displaying files which are managed by another file management system (not shown) which does not allow an object with an identical name to be stored.

In addition, the external file display function processing section 21 has a file information acquiring unit 25, a display processing unit 26, a naming processing unit 27, and a file name informing unit 28. At the time of displaying information concerning a file under management by the file management system B 15, the file information acquiring unit 25 acquires from the file management system B 15 information concerning that file, specifically the name and the extension of the file stored in the folder designated as the display object as well as at least an attribute value of the display attribute among attribute values of that file. The display processing unit 26 is realized by an application for displaying information concerning the files under management by the file management system B 15, and part of the information text acquired by the file information acquiring unit 25 is displayed on the display 8.

The naming processing unit 27 is provided as a name changing means, and in a case where the name of the file is identical to names of the other files in the folder designated as the storage destination of the file storage section 24 as the file management section 22 stores the file in response to a storage instruction, the naming processing unit 27 acquires at least the attribute value of the relevant storage-instructed file in the display attribute, and changes the name of that storage-instructed file to a name which includes the name of the storage-instructed file and the acquired attribute value of the storage-instructed file. It should be noted that the attribute value which is included in the name is, strictly speaking, character information representing the attribute value, but is described herein, for convenience' sake, as the “attribute value.” The file name informing unit 28 informs the file management section 22 of the name of the storage-instructed file. As the name to be informed, in the case where the name has been changed by the naming processing unit 27, the changed name of the file is informed, whereas if it has not been changed, the name of the file which is used in the file management system B 15 is informed as it is.

The respective constituent elements 21 to 23 in the file management system A 20 are realized through cooperative operation by the computer forming the file management system A 20 and a program which is operated by the CPU 1 installed on the computer. In addition, the file storage section 24 is realized by one or a plurality of HDDs 4 mounted in the file management system A 20. Alternatively, the file storage section 24 may be realized by an HDD installed on another computer using a file system which does not allow an object with an identical name to be stored.

In addition, the program which is used in this exemplary may, of course, be provided by a communication means and may also be provided by being stored in a recording medium which is readable by the computer, such as a CD-ROM or a DVD-ROM. As for the program provided by the communication means or the recording medium, various processing is realized as the program is installed on the computer and the CPU of the computer consecutively executes the installed program.

Next, a description will be given of the operation in this exemplary embodiment.

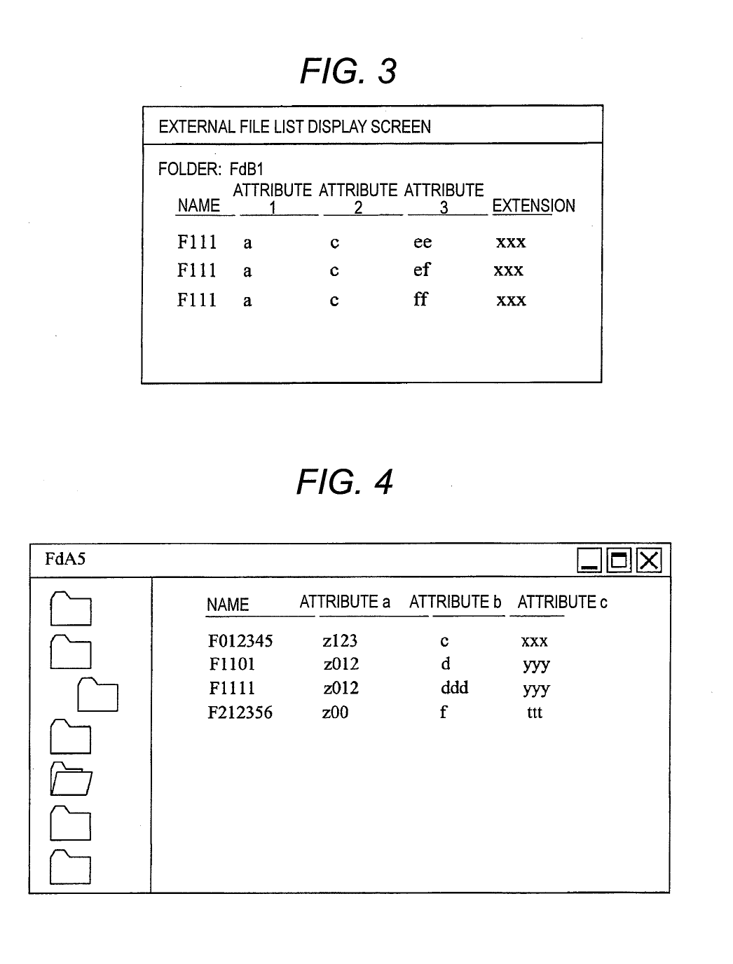

When a predetermined application is started in response to the user's operation, the external file display function processing section 21 starts the following processing. Namely, as the application is started, the file information acquiring unit 25 of the external file display function processing section 21 acquires from the file management system B 15 information concerning the files stored in the designated folder, specifically the names, attribute values, and extensions of the files. The display processing section 23 of the external file display function processing section 21 prepares a predetermined form on the display 8 and displays in that form the information acquire by the file information acquiring unit 25. One example of a screen displayed by this application is shown in FIG. 3. The names of the files stored in a folder “FdB1” and attribute values of the attributes and extensions which are set for these files in correspondence with the respective names are displayed in FIG. 3. Various attributes such as the date of preparation and the version numbers are set for each file, but the display attributes selected by the system or the user from among the attributes set for each file are displayed on the display 8. FIG. 3 shows an example in which an attribute 1, an attribute 2, and an attribute 3 are being displayed on the display 8 as display characteristics. Accordingly, the file information acquiring unit 25 may be arranged to acquire at least attribute values of a relevant file in display attributes necessary for display among the attributes which have been set in the file. Thus, the external file display function processing section 21 displays on the display 8 the information concerning the files under management by the file management system B 15.

Here, while referring to a list of files displayed by the external file display function processing section 21, to download any of the files among them to the file management system A 20, the user gives an instruction to store the relevant file by performing a predetermined operation. In terms of the predetermined operation for giving the storage instruction, if the display processing section 23 displays on the screen a folder “FdA5” serving as a storage destination, as illustrated by way of example in FIG. 4, the user may effect a drag & drop operation of a file on the display screen being displayed by the external file display function processing section 21 to a folder under management by the file management system A 20. Alternatively, a download command or a file registration instruction to the file management system A 20 by another application may be set as the storage instruction. In either case, all the instruction and operation in which the files under management by the file management system B 15 are stored in a folder under management by the file management system A 20 so as to be placed under management by the file management system A 20 correspond to the instruction for storage in a folder under management by the file management system A 20.

Hereafter, a description will be given of processing whereby a file under management by the file management system B 15 is placed under management by the file management system A 20 in response to the aforementioned storage instruction by a download.

When a storage instruction whereby a file under management by the file management system B 15 (hereafter, this file will be referred to as the “original file”) is placed under management by the file management system A 20 through the above-described operation or the like is accepted by a predetermined application or in response to the user's operation, the external file display function processing section 21 sends to the file management section 22 a request for storing the file designated as the storage object in a folder under management by the file management system A 20 and designated as the storage destination. In response to that request the file management section 22 determines whether or not the storage of the designated file in the designated storage destination is possible, and returns the result to the external file display function processing section 21. Since the file management system A 20 is a system which does not allow an object with an identical name to be stored in the folder under its management, in a case where a file with a name identical to that of the designated file is present in the folder designated as the storage destination, the file management section 22 returns the result of determination that the storage is impossible.

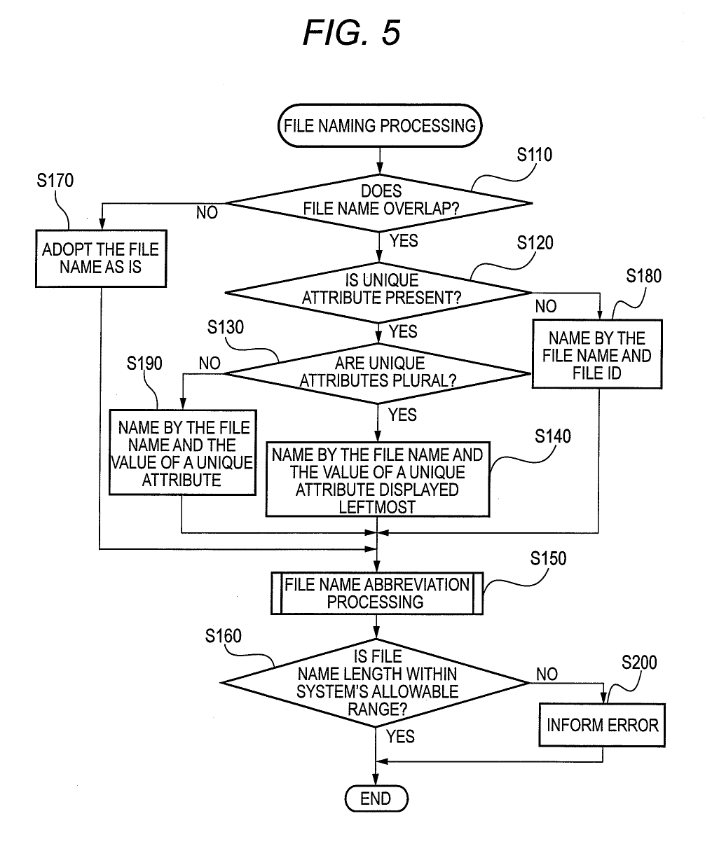

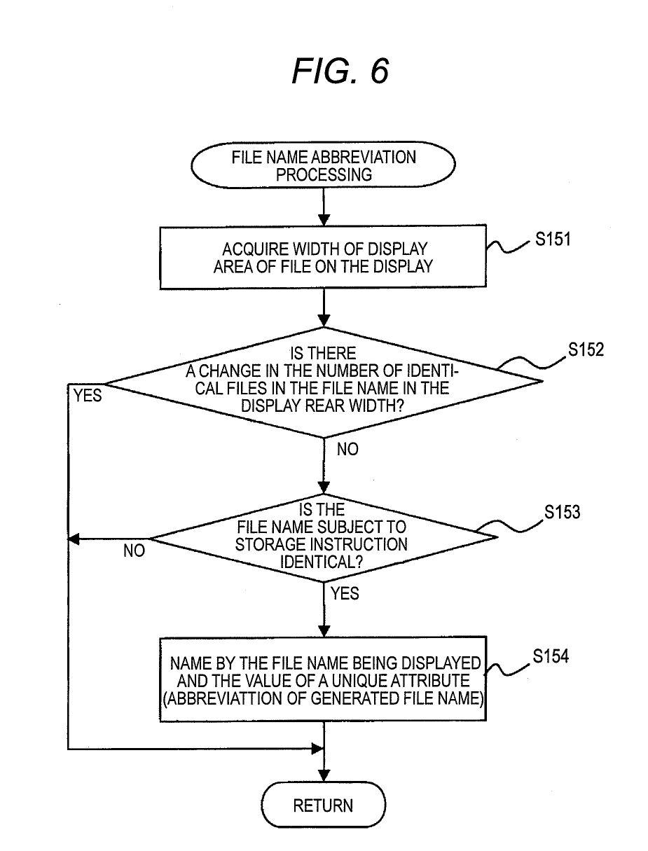

Hereafter, an example of processing by the external file display function processing section 21 after acceptance of the result of determination will be described by referring to the flowcharts of FIG. 5 and FIG. 6 respectively showing an example of file naming processing and an example of file name abbreviation processing.

In a case where the result of determination is returned from the file management section 22 that the storage of the file designated by the storage instruction is possible, i.e., in a case where a file whose file name is not identical to (does not overlap with) the original file designated by the storage instruction is not present in the storage destination (N in Step 110), the naming processing unit 27 of the external file display function processing section 21 adopts the name of that original file as it is (Step 170). It should be noted that, in this exemplary embodiment, the name of the file or the file name means a name imparted to the file which does not include an extension, but the determination of the presence or absence of an overlapping (identical) of the file name is made by the file name in which the name of the file and the extension are combined.

Meanwhile, in a case where a file whose name is identical to that of the original file has already been stored (Y in Step 110), since the file name overlaps (identical), a determination is made that the name of the original file cannot be stored as it is in the folder of the storage destination.

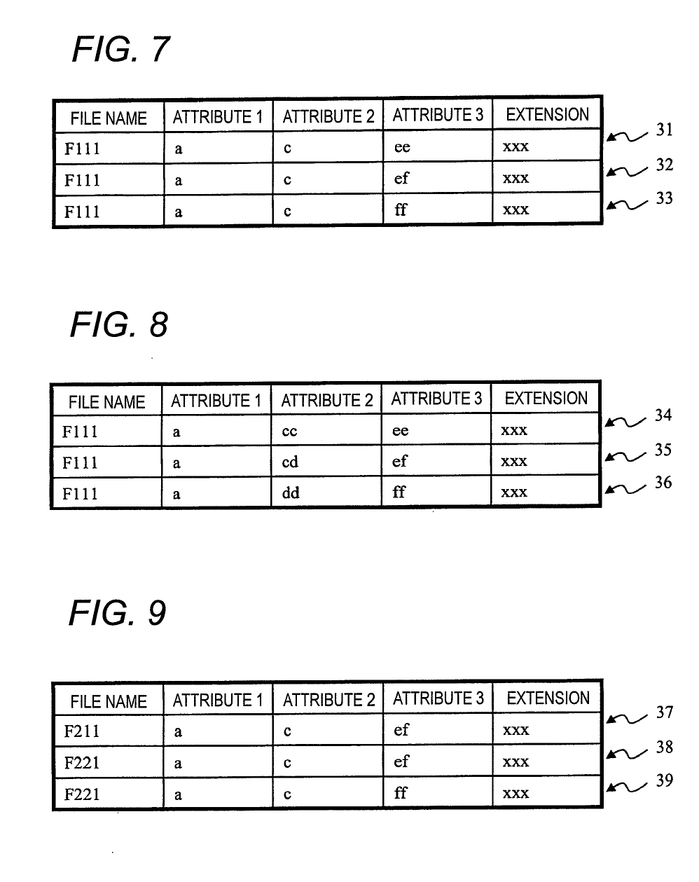

FIG. 7 is a diagram illustrating an example of a list of files stored in the folder “FdB1.” It should be noted that FIG. 3 shows an example of display at a time when the group of files shown in FIG. 7 are list-displayed on the display 8. For example, in a case where a file 31 shown in FIG. 7 is to be downloaded to the folder “FdA5,” based on the examples of FIGS. 3 and 4, a file “F111” whose name is identical to that of the original file “F111” under management by the file management system B 15 is present in the folder “FdA5,” so that the original file “F111” cannot be stored with that name intact.

Accordingly, the naming processing unit 27 changes the name of the original file by effecting the following processing. Namely, an examination is first made of whether a unique attribute is present in which attribute values set for the respective files are all different in the group of files with names identical to that of the original file in the file management system B 15. Then, if a unique display attribute is not present (N in Step 120), the naming processing unit 27 generates a file name by combining character strings the name of the original file and the file ID of the original file. The name of the original file is changed and renamed by the file name thus generated. It should be noted that since the file ID is identification information unique to each file and is representative information capable of identifying the file, the file ID is used as information which is combined with the file name in this exemplary embodiment in a case where a unique display attribute is not present. However, in a case where unique information other than the file ID has been set for each file, that information may be used instead of the file ID.

On the other hand, in a case where a unique display attribute is present (Y in Step 120), if a plurality of such unique display attributes are not present, i.e., if there is only one unique display attribute (N in Step 130), the naming processing unit 27 generates a file name by combining character strings of the name of the storage-instructed original file and the attribute value of that unique display attribute. The name of the original file is changed and renamed by this generated file name (Step 190). For example, according to the example of the setting of attribute values shown in FIG. 7, only the attribute 3 is the attribute in which unique attribute values have been set for the respective files 31 to 33 concerning the files “F111.” Accordingly, the naming processing unit 27 generates a file name by combining character strings of the name of the storage-instructed original file and the unique display attribute of the original file. Specifically, the name of the file 31 is changed from “F111” to “F111ee.”

In addition, in a case where a plurality of unique display attributes are present (Y in Step 130), the naming processing unit 27 selects a display attribute from among that plurality of display attributes in accordance with a predetermined rule changes the name of the original file and renames it to a name consisting of a combination of the storage-instructed original file name and the attribute value in that selected display attribute. FIG. 8 is a diagram illustrating another example of a list of files stored in the folder “FdB1” under management by the file management system B 15. It should be noted that, here, if the storage-instructed original file is assumed to be a file 34, according to the setting example of attribute values shown in FIG. 8, the attribute 2 and the attribute 3 are attributes in which unique attribute values have been set for the respective files 34 to 36 among the files 34, 35, and 36 of the same file name “F111.” In this case, in this exemplary embodiment, in order to improve the identifiability of files, an attribute whose position displayed by the display processing unit 26 is closest to the display position of the name of the file is selected from among the plurality of display attributes in accordance with a predetermined rule. In FIG. 8, since the file name is displayed in a leftmost display area on the display 8, the attribute 2 which is being displayed on the leftmost side by the display processing unit 26 is selected from among the unique display attributes. Accordingly, the naming processing unit 27 generates a file name by combining character strings of the name of the original file 34 and the selected unique display attribute of the original file. Namely, the name of the file 34 is changed from “F111” to “F111cc.”

As described above, in this exemplary embodiment, in a case where a file with a name identical to that of the storage-instructed original file is present in the storage destination, the original file is stored after changing the name of the original file to avoid the overlapping of the file name.

It should be noted that although in this exemplary embodiment an attribute which is closest to the display position of the name of the file is selected in accordance with a predetermined rule, the attribute may alternatively be selected in accordance with another rule such as by prioritizing attributes to be selected or according to such as the character string length of the attribute value.

In addition, although in this exemplary embodiment an attribute which is closest to the display position of the name of the file is selected in accordance with a predetermined rule, for example, a plurality of unique display attributes may alternatively be presented by being displayed on the display 8 as selection candidates to thereby impart to the name of the file the attribute value of the attribute selected by the user from among the presented attributes.

In addition, although in this exemplary embodiment a new name is generated by combining the entire character strings representing the name and the attribute value of the original file, parts of the character strings representing the name and the attribute value, e.g., character string portions being displayed on the display 8, may be combined insofar as it is possible to maintain the discrimination of the respective files.

Incidentally, in the description of Step 110 above, whether or not an overlapping of the name of the file can occur is determined according to whether or not a file whose name is identical to that of the original file under management by the file management system B 15 is already present in the folder designated as the storage destination under management by the file management system A 20. If, for example, it is clear that a storage instruction to the file 32 or the file 33 is not made after a storage instruction to the file 31 shown in FIG. 7 has been made, even if the attribute value of not the attribute 3 but an arbitrary display attribute of the attribute 1 or the attribute 2 is added to the name of the file 31, an overlapping of the file name with the already present file “F111” under management by the file management system A 20 does not occur. Namely, a unique attribute value need not necessarily be used as the attribute value to be combined with the file name.

In addition, a case is assumed in which a plurality of files whose names are identical to that of the storage-instructed file and whose attribute values are unique are present in a folder under management by the file management system B 15, i.e., although the respective attribute values of the files 32 and 33 with names identical to that of the storage-instructed file 31 in FIG. 7 are unique, it is assumed that the attribute value of the attribute 3 of the file 33 in FIG. 7 is not “ff” but “ef.” Even if the attribute values of the files 32 and 33 are thus identical, they differ from the attribute value of the storage-instructed file 31. Accordingly, if it is clear that storage instructions to the file 32 and the file 33 are not made after a storage instruction to the file 31 has been made, the attribute value “ee” of the attribute 3, which is different from the attribute values of the other files 32 and 33, may be used as the attribute value to be combined with the name of the file 31, and a unique attribute value need not necessarily be used.

However, a case is easily conceivable in which a storage instruction is successively made to the file 32 or the file 33 after the storage instruction to the file 31 has been made. Accordingly, if consideration is given to such a case or a case where a plurality of files are simultaneously selected as a file subject to storage instruction among the files 31 to 33 with an identical name, instead of effecting such naming as to be able to merely avoid an overlapping of the name with a file under management by the file management system A 20, even if a file with a name identical to that of the storage-instructed file is not present in the folder under management by the file management system A 20 and designated as the storage destination, if a file with a name identical to that of the storage-instructed file is present in the file management system B 15, it is preferable to store the file in the file management system A 20 after changing the name of the file. Namely, in this exemplary embodiment, cases where the name of a file overlaps in a folder designated as the storage destination in the file storage section 24 as the file management section 22 stores the file in response to a storage instruction, are applicable not only to cases where a file with an identical name is present in the folder designated as the storage destination, but also to cases where even if a file with an identical name is not actually present at the current moment in the folder designated as the storage destination, a file with a name identical to that of the storage-instructed file is present in the file management system B 15.

As described above, in this exemplary embodiment, since a file name is generated by adding an attribute value to the original file name, the length of a new file name becomes longer than the original file name. In addition, there can be cases where the file name length which is allowed in the file management system B 15 cannot be approved in the file management system A 20. Accordingly, in this exemplary embodiment, processing for abbreviating the file name is provided with respect to the generated file name (Step 150).

Incidentally, in conjunction with the starting of an application in a predetermined manner, the display processing unit 26 displays in the window information on the files in the designated folder. Specifically, the display processing unit 26 displays respective display items including the names of the files in the folder, attribute values of a plurality of display attributes, extensions, and the like by juxtaposing them in a horizontal direction of the display 8. At this time, there can be cases where the entire character string representing the name is not displayed on the display 8 depending on the settings by the user or the system, including such as the number of display items, the width of the display window, and the width of the display area in each display item within the display window. It should be noted that, at that time, the user discriminates the file by the displayed portion of the name of the file and the corresponding attribute value and extension. In this exemplary embodiment, the name of the file is adapted to be abbreviated, as required, by making use of the character string of the name of the file being displayed in the display area. A description will be given of one example of this file name abbreviation processing with reference to the flowchart shown in FIG. 6.

When the name of the original file is determined in the above-described processing, the naming processing unit 27 subsequently acquires the length of the file name being actually displayed on the display 8 by the display processing unit 26, i.e., the width of the display area for displaying the name of the file in a predetermined form for displaying the list of files (Step 151). Consequently, the naming processing unit 27 acquires the file name of the portion being actually displayed on the display 8 in the name of the file, i.e., the character string of the file name being displayed.

Here, an examination is made of whether or not the number of overlapping files in the actual name of the file and the number of overlapping files in the file names being displayed in the display area of the names of files have changed. Then, if the number of files has changed (Y in Step 152), the file name generated in the above-described processing is adopted as it is. Namely, the abbreviation of the file name is not carried out. On the other hand, in a case where the number of files has not changed (N in Step 152), if the name of a file overlapping with the storage-instructed file is not present (N in Step 153), the file name generated in the above-described processing is adopted as it is. Further, if the name of a file overlapping with the storage-instructed file is present (Y in Step 153), the name of the file is changed to one which combines a character string representing the file name of the portion being actually displayed, i.e., the file name being displayed in the display area, in the file name and a unique attribute value (Step 154). In other words, the character string of the portion being not displayed in the file name is deleted, so that the name of the file becomes shorter by the portion of the length of this deleted character string.

Thus, in this exemplary embodiment, in the case where the width of the display area of the file name in the display processing unit 26 is narrower than the length of the file name, the name of the file is changed to one which combines the portion being displayed in the display area in the name of the file and the attribute value of the storage-instructed file if the number of files with actual identical names and the number of files with identical names being displayed change, i.e., if the number is different and the name of the storage-instructed file overlaps. The above-described file name abbreviation processing will be described by citing a specific example.

For example, FIG. 9 shows an example of files being managed by the file management system B 15 and stored in a folder. A description will be given of a case where these files are stored in the file management system A 20, and the display area of the name of the file has a width of a 2-character portion,

In this case, the files “F211,” “F221,” and “F221” illustrated in FIG. 9 are displayed on the display 8 as “F2,” “F2,” and “F2,” respectively. It should be noted that since the file names appear to be identical, the user discriminates the files by referring to the attribute values.

Here, if attention is focused on the file “F211” among the three files illustrated in FIG. 9, an overlapping does not occur in the actual name of the file. If there is not overlapping, it can be said that the number of files with identical names is 1. Further, in the case where the display area of the name of the file has a 2-character portion, the names of the three files are “F2,” “F2,” and “F2,” i.e., the number of files with identical names in the display area is 3. Thus, since the number of overlapping files changes from 1 to 3 when the actual name of the file is actually displayed in the display area (Y in Step 152), the name of the file “F211” is kept intact.

Next, if attention is focused on the file “F221” among the three files, this name overlaps, and the number of files with identical names is 2. Further, in the case where the display area of the name of the file has a 2-character portion, the names of the three files are “F2,” “F2,” and “F2,” i.e., the number of files with identical names in the display area is 3. Thus, since the number of overlapping files changes from 1 to 3 when the actual name of the file is actually displayed in the display area (Y in Step 152), the name of the file “F211” is kept intact. Further, in the case of an identical name, since the attribute value of a unique attribute is added to the file name, the name of the file of a file 38 becomes “F221ef,” and the name of the file of a file 39 becomes “F221ff,”

In addition, a description will be given of a case where the display area of the name of the file has a 3-character portion. If attention is focused on the file “F211” among the three files illustrated in FIG. 9, there are no overlapping files. Namely, the number of files with identical names is 1. Further, in the case where the display area of the name of the file has a 3-character portion, the names of the three files are “F21,” “F21,” and “F21,” i.e., the number of files with a name identical to that of “F211” in the display area is 1. Thus, the number of overlapping files does not change (i.e., from 1 to 1) when the actual name of the file is actually displayed in the display area (N in Step 152). Then, since the name “F211” of the storage-instructed file does not overlap with other files (N in Step 153), the name of the file “F211” is kept intact.

Next, if attention is focused on the file “F221” among the three files, this name overlaps, and the number of files with identical names is 2. Further, in the case where the display area of the name of the file has a 3-character portion, the names of the three files are “F21,” “F21,” and “F21,” i.e., the number of files with identical names in the display area is 2. Thus, the number of overlapping files does not change (i.e., from 2 to 2) when the actual name of the file is actually displayed in the display area (N in Step 152). Then, since the name “F211” of the storage-instructed file overlaps (Y in Step 153), in the case where the storage-instructed file is the file 38, as the attribute value “ef” of the unique attribute 3 is added to the 3-character name “F22” being displayed in the displayed file name, the name of the file is abbreviated as “F22ef” (Step 154). In addition, in the case where the storage-instructed file is the file 39, as the attribute value “ff” of the unique attribute 3 is added to the 3-character name “F22” being displayed in the displayed file name, the name of the file is abbreviated as “F22ff” (Step 154).

When the name is determined for the storage-instructed file in the above-described manner, if its file name length exceeds the allowable range of the file management system A 20 (N in Step 160), it is determined that the storage-instructed file cannot be placed under management by the file management system A 20, and the user or the like is informed to that effect (Step 200).

When the thus-generated name is informed, the file management section 22 stores the original file in the folder of the designated storage destination with the informed name, in the folder “FdB5” in the case of this example.

In this exemplary embodiment, the name is thus changed to avoid the overlapping of the name of the file, as required, so as to allow a file under management by the file management system B 15 to be placed under management by the file management system A 20 which does not allow an object with an identical name to be stored in a folder.

It should be noted that, in this exemplary embodiment, the naming processing unit 27 for effecting the naming of the file is provided in the external file display function processing section 21 for effecting the display processing in the file management system B 15, and the named name of the file is informed to the file management section 22 for effecting the management of files under management by the file management system A 20. Namely, although the naming processing unit 27 is provided in the external file display function processing section 21 as a function of the application which realizes the external file display function processing section 21, this exemplary embodiment is only one form of the object management apparatus, and the naming function in the naming processing unit 27 need not necessarily be provided in the external file display function processing section 21.

Incidentally, in this exemplary embodiment, a description has been given by citing as an example the case in which a file under management by the file management system B 15 which allows an object with an identical name to be stored in a folder is placed under management by the file management system A 20 which does not allow an object with an identical name to be stored in a folder. However, this is only one example and is also applicable to a case in which a file under management by a file management system which does not allow an object with an identical name to be stored in a folder is placed under management by a file management system which does not allow an object with an identical name to be stored in a folder. Further, in this case, it is possible to use a computer in which file management systems at the storage origin and the storage destination are identical. For example, this invention is also applicable to a case in which two windows for displaying information concerning files are opened on the display 8 by starting twice the application for display which realizes the display processing section 23, and a file of a certain folder displayed in one window is copied to a folder displayed in the other window by a drag & drop operation or the like, wherein a file with an identical name is present in the folder of the storage destination.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for managing an object, the process comprising:
displaying a first name of a first object stored in a first storage area;
displaying a second name of a second object stored in a second storage area together with at least one of items of a second attribute of the second object, the at least one of the items being selected as an object to be displayed;
storing the second object stored in the second storage area in the first storage area in response to a storage instruction for storing the second object in the first storage area; and
acquiring the at least one of the items of the second attribute;
editing the second name to include the second name and the at least one of the items of the second attribute when the first name becomes identical to the second name of the second object stored in the first storage area due to the storage instruction.

2. The computer readable medium according to claim 1, wherein in case where:
the second storage area is provided in a system which allows an object with an identical name to be stored;
the second storage area stores a third object having a third name identical to the second name; and
the second attribute is different from a third attribute of the third object in the at least one of the items,
further comprising editing the second name to include the second name and the at least one of the items of the second attribute.

3. The computer readable medium according to claim 1 further comprising in a case where:
the second storage area is provided in a system which allows an object with an identical name to be stored;
the second storage area stores a third object having a third name identical to the second name; and
the second attribute is different from a third attribute of the third object in at least two of the items,
editing the second name to include the second name and a given item of the second attribute, the given item being displayed the closest position to the second name in the two of the items.

4. The computer readable medium according to claim 1 further comprising in a case where:
the second storage area is provided in a system which allows an object with an identical name to be stored;
the second storage area stores a third object having a third name identical to the second name; and
the second attribute is different from a third attribute of the third object in at least two of the items,
presenting to a user the two of items as selection candidates; and
editing the second name to include the second name and a given item of the second attribute, the given item being selected by the user from the two of items.

5. The computer readable medium according to claim 1 further comprising in a case where:
length of the second name is longer than a displayable length in the displaying step,
the second name in the displayable length is not identical any object names in the first storage area,
editing the second mane to include the second name in the displayable length and the at least one of the items.

6. An object management apparatus comprising:
a first storage area that stores a first object having a first attribute and a first name;
a first object display unit that displays the first name;
a second object display unit that displays a second name of a second object together with at least one of items of an second attribute of the second object, the at least one of the items being selected as an object to be displayed;
a storage processing unit that stores the second object stored in the second storage area in the first storage area in response to a storage instruction for storing the second object in the first storage area; and
a name changing unit that acquires the at least one of the items and edits the second name to include the second name and the at least one of the items when the first name becomes identical to the second name of the second object stored in the first storage area due to the storage instruction.

7. The object management apparatus according to claim 6, the name changing unit edits the second name to be different from the first name.
